(19) United States
(12) Patent Application Publication
(10) Pub. No.: US 2010/0063872 A1
(43) Pub. Date: Mar. 11, 2010

(54) METHOD AND APPARATUS FOR DELIVERING A BARCODE REPRESENTING A PLURALITY OF COUPONS

(76) Inventors: Pulin Patel, Morris Plains, NJ (US); Bihari Srinivasan, Andover, MA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 12/555,412

(22) Filed: Sep. 8, 2009

Related U.S. Application Data
(60) Provisional application No. 61/096,228, filed on Sep. 11, 2008.

(51) Int. Cl. G06Q 30/00; G06K 15/00; G06F 17/30; H04W 4/12

(52) U.S. Cl. 705/14.1; 235/383; 707/705; 455/466; 707/E17.001

(57) ABSTRACT

Generating a barcode representing a plurality of coupons and initiating a transmission of the barcode to a barcode display device by receiving a first request from a user for a first coupon at the server, generating a new barcode, associating the barcode with the user, receiving a second request for a second coupon, associating the first coupon and the second coupon with the barcode, and initiating a transmission of the barcode to a barcode display device.

### I. RELATED APPLICATIONS

The present application claims the benefit and priority under 35 U.S.C. §119 of U.S. provisional application No. 61/096,228 filed on Sep. 11, 2008, hereby incorporated by reference in its entirety.

### II. TECHNICAL FIELD

The present disclosure generally relates to delivering a plurality of coupons using a single barcode.

### III. GOVERNMENT FUNDING

N/A

### IV. BACKGROUND

Consumers have used coupons since the early 1900s to receive discounts on consumer products. Coupons were originally distributed in paper format and would be redeemed by the consumer by physically presenting the coupon in a store. Most modern coupons arc processed through the use of a barcode. The barcodes are encoded to allow a barcode scanner at the store to recognize the discount associated with the coupon. Once the barcode scanner has recognized the coupon, the register applies the discount to the consumer's purchase.

Recently, companies have started to send coupons to consumers via cellular phone. Technology exists that allows a typical barcode scanner to read a coupon that is displayed on a cellular phone display. Companies use cellular networks and special software to display the coupons on the cellular phones. Using special software presents a problem for many consumers with entry level phones or with older phones because their phones may be unable to run the special software, preventing them from using the system. Therefore, a system that eliminates the need for a cellular phone to run special software is needed.

Also, problems arise in the current systems when a consumer wants to apply a plurality of coupons to a purchase. For example, many consumers use a plurality of coupons at grocery stores when buying several items. Currently, a consumer must scan each coupon individually to apply them to the purchase. Scanning each coupon individually on a cellular phone requires displaying and scanning each barcode on the phone display. This causes delays due to the overhead associated with pulling up and displaying the individual barcodes. Most retailers will not adopt a system that increases checkout times. Therefore, a system that eliminates the need for the consumer to display and scan a plurality of barcodes to apply a plurality of discounts is needed.

### V. SUMMARY

The embodiments described in this document relate to server and a method for generating a barcode representing a plurality of coupons and initiating a transmission of the barcode to a barcode display device. The method may be implemented, at least in part, by receiving a first request from a user for a first at least one coupon at the server, generating a new barcode, associating the barcode with the user, receiving a second request for a second at least one coupon, associating the first at least one coupon and the second at least one coupon with the barcode, and initiating a transmission of the barcode to a barcode display device. The method may be further implemented by receiving and displaying the barcode on the barcode display device, scanning the barcode and retrieving the data on the barcode using a barcode reading device and, applying the requested at least one coupon associated with the barcode to a purchase. The barcode generated by the server may be encoded in at least three different manners: database passkey, data fully encoded, or partial data encoded and database passkey. Where the barcode is encoded with a database passkey, generating a new barcode will further comprise: associating the barcode with a passkey for a database and retrieving the data on the barcode further comprises: decoding the passkey associated with the barcode using the database. Where the barcode is encoded with full data, generating a new barcode further comprises: coding all requested coupons into the barcode data and retrieving the data on the barcode further comprises: decoding the barcode data. Where the barcode is encoded with partial data and partial database passkey, generating a new barcode further comprises: associating the barcode with a partial passkey for a database and coding the barcode with partial coupon data and retrieving the data on the barcode further comprises: decoding the partial passkey associated with the barcode using the database and decoding the partial coupon data. One embodiment of the invention includes sending an advertisement along with the barcode to the user. In that embodiment, associating the coupons with the barcode further comprises: combining the barcode with an advertisement. The barcode and/or advertisements may be sent using SMS or MMS messaging.

An alternative embodiment may include initiating a transmission of a barcode representing a plurality of coupons to a barcode display device. The embodiment may be implemented, at least in part, by receiving a request from a user for at least one coupon at the server, retrieving a barcode and at least one previously associated coupon corresponding with the user, associating the user requested at least one coupon and the at least one previously associated coupon with the retrieved barcode, and initiating a transmission of the barcode to the barcode display device. The embodiment may be further implemented by receiving and displaying the barcode on the barcode display device, scanning the barcode and retrieving the data on the barcode using a barcode reading device, and applying the requested coupons associated with the barcode to a purchase. The barcode generated by the server may be encoded in at least three different manners: database passkey, data fully encoded, or partial data encoded and database passkey. Where the barcode is encoded with a database passkey, associating the user requested at least one coupon and the at least one previously associated coupon with the retrieved barcode further comprises associating the barcode with a passkey for a database, and retrieving the data on the barcode further comprises decoding the passkey associated with the barcode using said database. Where the barcode is fully encoded with data, associating the user requested at least one coupon and the at least one previously associated coupon with the retrieved barcode further comprises coding all requested coupons into the barcode data and retrieving the data on the barcode further comprises decoding the barcode data. Where the barcode is a partial data encoded and partial database passkey, associating the user requested at least one coupon and the at least one previously associated coupon with the retrieved barcode further comprises associating the barcode with a partial passkey for a database and coding the barcode with partial coupon data and retrieving the data on the barcode further comprises decoding the partial passkey associated with the barcode using the database and decoding the partial coupon data. One embodiment of the invention includes sending an advertisement along with the barcode to the user. In that embodiment, associating the user requested at least one coupon and the at least one previously associated coupon with the retrieved barcode further comprises combining the barcode with an advertisement. The barcode and/or advertisements may be sent using SMS or MMS messaging.

An additional alternative embodiment may include generating a barcode representing a plurality of coupons and initiating a transmission of a barcode representing a plurality of coupons to a barcode display device. The embodiment may be implemented, at least in part, by receiving at least one request from a user for a plurality of coupons at the server, generating a barcode, associating the plurality of coupons with the barcode, and initiating a transmission of the barcode to a barcode display device. The embodiment may be further implemented by receiving and displaying the barcode on the barcode display device, scanning the barcode and retrieving the data on the barcode using a barcode reading device, applying the requested coupons associated with the barcode to a purchase. The barcode generated by the server may be encoded in at least three different manners: database passkey, data fully encoded, or partial data encoded and database passkey. Where the barcode is encoded with a database passkey, associating the user requested plurality of coupons with the retrieved barcode further comprises associating the barcode with a passkey for a database and retrieving the data on the barcode further comprises decoding the passkey associated with the barcode using the database. Where the data is fully encoded on the barcode, associating the user requested plurality of coupons with the retrieved barcode further comprises coding all requested coupons into the barcode data and retrieving the data on the barcode further comprises decoding the barcode data. Where the barcode comprises partial data and a partial database passkey, associating the user requested plurality of coupons with the retrieved barcode further comprises associating the barcode with a partial passkey for a database and coding the barcode with partial coupon data and retrieving the data on the barcode further comprises decoding the partial passkey associated with the barcode using the database and decoding the partial coupon data. One embodiment of the invention includes sending an advertisement along with the barcode to the user. In that embodiment, associating the plurality of coupons with the barcode further comprises combining the barcode with an advertisement. The barcode and/or advertisements may be sent using email, or other communication methods that would allow the barcode display device to receive the barcode from the host server.

An additional alternative embodiment includes initiating a transmission of a barcode representing a plurality of coupons to a barcode display device. The embodiment may be implemented, at least in part by, receiving at least one request from a user for a plurality of coupons at the server, retrieving a barcode that corresponds to the user, associating the plurality of coupons with the barcode, and initiating a transmission of the barcode to a barcode display device. The embodiment may be used to include previously selected unused coupons in the current coupon request. In this embodiment, retrieving a barcode that corresponds to the user includes retrieving at least one previously associated coupon corresponding with the user; and associating the plurality of coupons with the barcode includes associating the plurality of coupons and the at least one previously associated coupon with the barcode. The embodiment may be further implemented by receiving and displaying the barcode on the barcode display device, scanning the barcode and retrieving the data on the barcode using a barcode reading device, and applying the requested coupons associated with the barcode to a purchase. The barcode generated by the server may be encoded in at least three different manners: database passkey, data fully encoded, or partial data encoded and database passkey. Where the barcode includes a database passkey, associating the user requested plurality of coupons with the retrieved barcode further comprises associating the barcode with a passkey for a database and retrieving the data on the barcode further comprises decoding the passkey associated with the barcode using the database. Where the data is fully encoded on the barcode, associating the user requested plurality of coupons with the retrieved barcode further comprises coding all requested coupons into the barcode data and retrieving the data on said barcode further comprises decoding said barcode data. Where the data is partially encoded and barcode includes a partial database passkey, associating the user requested plurality of coupons with the retrieved barcode further comprises associating the barcode with a partial passkey for a database and coding the barcode with partial coupon data and retrieving the data on the barcode further comprises decoding the partial passkey associated with the barcode using the database and decoding the partial coupon data. One embodiment of the invention includes sending an advertisement along with the barcode to the user. In that embodiment, associating said plurality of coupons with said barcode further comprises combining said barcode with an advertisement. The barcode and/or advertisements may be sent using email, or other communication methods that would allow the barcode display device to receive the barcode from the host server.

One embodiment includes a server for generating a barcode, associating it with a plurality of coupons, and initiating a transmission of the barcode to a barcode display device. The server includes a processor, a memory, and a transceiver. The transceiver may be configured to receive at least one request for at least one coupon, the at least one request for at least one coupon identifying a plurality of coupons. The transceiver may also initiate a transmission of a barcode associated with the multiple coupons identified by the at least one request for at least one coupon to a barcode display device. The memory may be configured to store coupons and barcodes. The processor may be configured to receive the at least one request for at least one coupon and associate the plurality of coupons with the barcode. The memory may be further configured to store at least one advertisement. The processor may be further configured to combine the at least one advertisement with the barcode associated with the plurality of coupons. The transceiver is further configured to initiate a transmission of the barcode associated with the plurality of coupons and the at least one advertisement to the barcode display device.

Other uses for the methods and apparatus given herein can be developed by those skilled in the art upon comprehending the present disclosure.

### VI. BRIEF DESCRIPTION OF THE DRAWINGS

For a fuller understanding of the nature and advantages of the present invention, reference is made to the following detailed description of preferred embodiments in connection with the accompanying drawings, in which:

FIG. 1 is a block diagram illustrating a system for generating and scanning a barcode representing a plurality of coupons.

FIG. 2 is a block diagram of a system for supporting a device for generating a barcode and associating it with a plurality of coupons.

FIG. 3 is a block diagram of a server for generating a barcode representing a plurality of coupons.

FIG. 4 is block diagram of an apparatus for scanning a barcode representing a plurality of coupons and applying the coupons to a purchase.

FIG. 5 is a flowchart of a method for generating a barcode and associating it with a plurality of coupons that were requested through SMS messaging or some other similar messaging service.

FIG. 6 is a flowchart of a method for generating a barcode and associating it with a plurality of coupons that were requested through the World Wide Web.

FIG. 7 is a flowchart of a method for generating a barcode, associating it with a plurality of coupons, and uploading to a download service which also includes downloading to portable devices.

FIG. 8 is a flowchart of a method for retrieving data on a barcode representing a plurality of coupons.

### VII. DETAILED DESCRIPTION

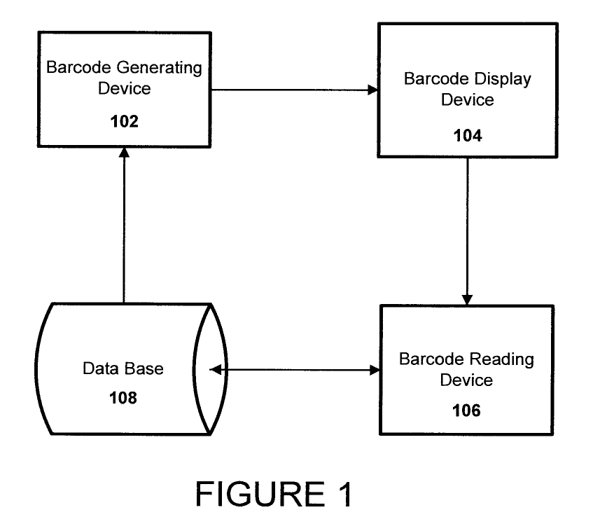

FIG. 1 represents a system for generating and scanning a barcode representing a plurality of coupons. The system includes a barcode generating device 102, a barcode display device 104, a barcode reading device 106, and a database 108. In one embodiment, the barcode generating device 102 may generate a barcode and associate the barcode with a personal identifier such as a phone number or some other personal identifier. The barcode generator 102 may further associate the'barcode with a plurality of coupons. The barcode generating device 102 may use the database 108 to associate the barcode with the user identifier and the coupons.

The barcode generating device 102 may initiate a transmission of the barcode to the barcode display device 104. The barcode display device 104 may display the barcode for scanning by the barcode reading device 106. The barcode reading device 106 may be used to scan the barcode displayed by the barcode display device 104. The barcode reading device 106 may use the database 108 or a local database with similar properties to determine the coupons associated with the scanned barcode. In one embodiment, the barcode will serve as a passkey to the database 108 or the local database. Alternatively, the barcode may be coded to comprise all relevant coupon data or may comprise a combination of a passkey and coded data. The coupon may he applied to the purchase by the barcode reading device 106 or another device downstream.

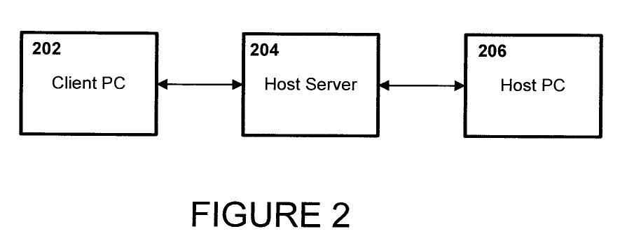

FIG. 2 is a block diagram of a system for supporting a device for generating a barcode and associating it with a plurality of coupons. In one embodiment, the system may comprise a host PC 206, a host server 204, and a client PC 202. The host PC 206 may be used by the hosting company to build, test, and update programs that will be used on the host server 204. The client PC may be used by the client company running the coupon promotion to create and manage coupon and promotion campaigns that will be run from the host server 204. The host server may be used to run the ‘live’ program. The ‘live’ program may be built, tested, and updated by the hosting company using the host PC 206. Coupon and promotion campaign parameters may be set by the client company using the client PC. The coupon and promotion campaign parameters may include: start and end date, amount or percentage of discount, and/or promotional messages.

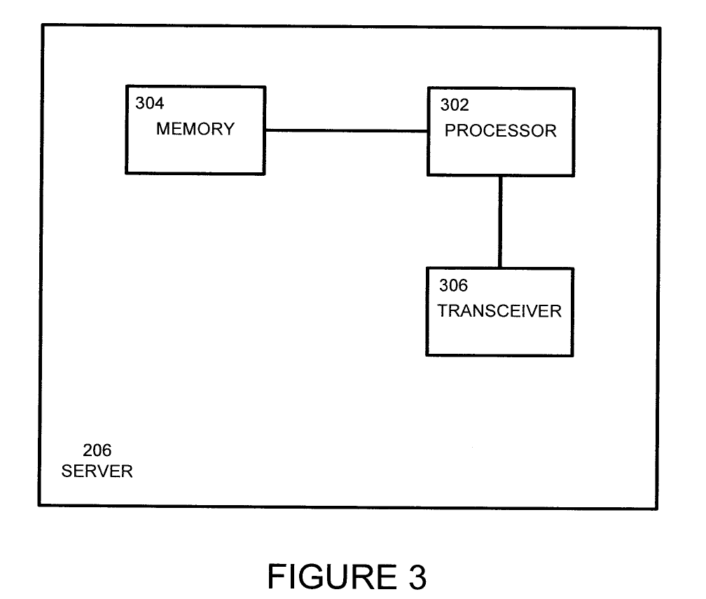

FIG. 3 is a block diagram of a server for generating a barcode representing a plurality of coupons. In one embodiment, the server 300 may comprise a processor 302, a memory 304, and a transceiver 306. The transceiver 306 may be configured to receive one or more requests for either a single or a plurality of coupons, depending on the embodiment, and transfer them to the processor 302. The transceiver 306 may also be configured to initiate transmission of an email, SMS, MMS or other type of message comprising a barcode, generated by the processor 302, representing a plurality of coupons to a portable display device. The transceiver 306 may be configured to send transmissions through typical wired and wireless communication channels. For example, these methods include Ethernet protocols, phone lines, USB, Firewire, cellular networks, IEEE 802.11 based standards (Wifi), IEEE 802.15 based standards (Bluetooth), and other types of communication channels. The transceiver 306 may be any logic, or combination of logic that allows the server to send and receive data. The server 300 may further comprise a memory 304. The memory 304 may store barcode data, barcode images and coupon data. The memory 304 may be used to store the user-barcode-coupon associations, performed by the processor 302. The server 300 may further comprise a processor 302. The processor 302 may be configured to receive one or more requests for either a single or a plurality of coupons, depending on the embodiment, from the transceiver 306. The requests may include user data and coupon data detailing the user requesting the coupon and the coupon(s) requested by the user. The processor 302 may use the user data to determine whether a user is a new user. If the user is not a new user, the processor 302 may retrieve a previously generated barcode associated with the user from the memory 304. If the user is a new user, the processor 302 may be used to generate a new barcode to be associated with the user and stored in memory 304. The processor 302 may be further configured to associate the retrieved or generated barcode with the coupons requested in the coupon data and send the barcode to the transceiver 306.

In alternative embodiment, the server 300 may be configured to send an advertisement along with the barcode to a barcode display device. In this alternative embodiment, the memory 304 will be further configured to store advertisements. The memory 304 may also store a user profile that tracks the user's coupon requests. The processor 302 may be further configured to combine the retrieved or generated barcode with an advertisement stored in memory 304. The processor 302 may be further configured to use the user profile stored in memory 304 to pick an advertisement to use. The transceiver 306 may be further configured to receive the advertisement-barcode combination from the processor 302 and initiate a transmission of the advertisement-barcode combination to the barcode display device.

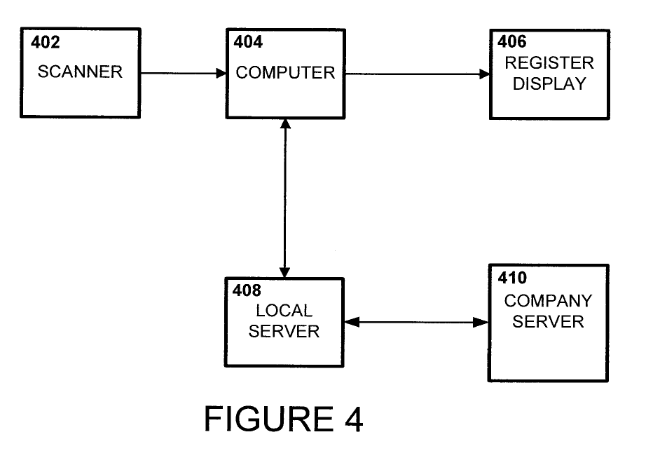

FIG. 4 is a block diagram of an apparatus for scanning a barcode representing a plurality of coupons and applying the coupons to a purchase. In one embodiment, the barcode reading device includes a scanner 402 and a computer 404. The computer 404 is coupled to a register display 406 and a local server 408. The local server communicates with a host server 410. The local server 408 may communicate with the host server 410 using various communications methods, including a direct connection, telephone line, and internet connection. In operation, the barcode reading device may scan the barcode using the scanner 402 and process the barcode using at least one of the computer 404, the local server 408 and the host server 410. Once the barcode has been processed, the computer 404 may display the discount on the register display 406. In an alternative embodiment, the local server 408 and the host server 410 may be the same server. This server would be coupled to the computer 404 through some communication line which may be wired or wireless. Examples of such communication lines include: WiFi, Phone Line, Internet, Ethernet and other communication protocols.

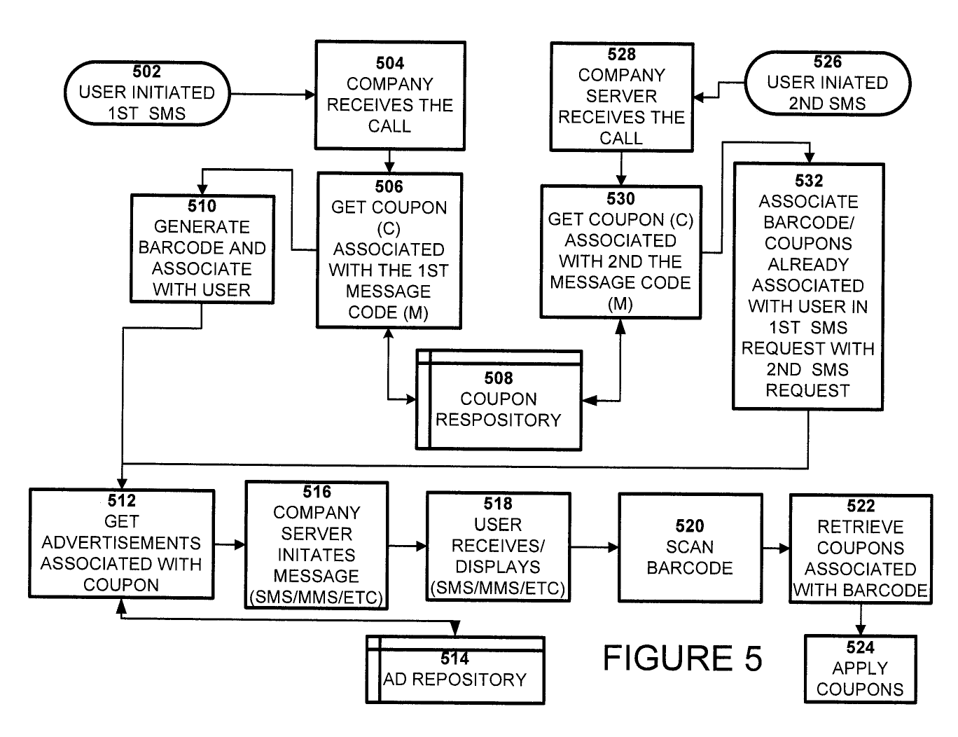

FIG. 5 is a flowchart of a method for generating a barcode and associating it with a plurality of coupons that were requested through SMS messaging or some other similar messaging service. In one embodiment, the user may request a first coupon through the use of SMS messaging using a portable device. The user may initiate a request for the first coupon by sending a first SMS message 502. The user may initiate the exchange in response to viewing an advertisement listing a message code and a specific short code. These advertisements may include, but are not limited to, in-store displays, printed publication, and multimedia advertisements on television or the internet. The host server may receive the request from the user 504. The host server may access a coupon repository 508 to retrieve the first coupon requested by the first user SMS message 506. If the user is new, the host server may generate a new barcode and associate it with the user 510. For example, the host server, may use a personal user identifier, such as a phone number or other unique ID, to identify the user and may associate the barcode with the user's unique ID. The host server may associate the barcode with the first coupon retrieved from the coupon repository 508, 512. The host server may retrieve advertisements from an advertisement repository 516 and combine the barcode and the advertisement into an SMS message 514. The host server may select advertisements using location of the user, time coupon request was sent or current time, gender of user, age of user, previous coupons requested, and previous coupons redeemed. The host server may select advertisements based on any data available in the coupon request or user profile. The host server may initiate a transmission of an SMS message to the user including the barcode and advertisement 518. The user may receive the SMS message and display the barcode and the advertisement on their portable device 520. The user may then scan the barcode using a barcode reading device at the place of purchase 522. The barcode reading device may retrieve the first coupon associated with the user and apply the coupon to the purchase 524, 526. The barcode reading device may retrieve the coupons using a local database that is synced with the host server to include the information necessary to decode the barcode. Alternatively, the barcode reading device may be coupled to the host server through a wired or wireless connection and may use the information on the host server to decode the barcode.

The user may initiate a second SMS request for coupon. If the second request is sent after using the first requested coupon, the host server will retrieve the user's barcode and repeat the relevant steps of the first SMS request. If the second request is sent prior to using the first requested coupon 528, the host server may receive the request and retrieve the user information associated with the user, such as the barcode and coupons currently associated with the user 530 (e.g., the first coupon). The host server may then retrieve the second coupon requested by the user in the second SMS request 532. The host server may associate the barcode with the second coupon requested in the second SMS request in addition to the first coupon requested in the first SMS request, resulting in the barcode being associated with a plurality of coupons.

The host server may retrieve advertisements from an advertisement repository 516 and combine the barcode and the advertisement into an SMS message 514. The host server may select advertisements using location of the user, time coupon request was sent or current time, gender of user, age of user, previous coupons requested, and previous coupons redeemed. The host server may select advertisements based on any data available in the coupon request or user profile. The host server may initiate a transmission of an SMS message to the user including the barcode and advertisement 518. The user may receive the SMS message and display the barcode and the advertisement on their portable device 520. The user may then scan the barcode using a barcode reading device at the place of purchase 522. The barcode reading device may retrieve the coupons associated with the user and apply those coupons to the purchase 524, 526. The barcode reading device may retrieve the coupons using a local database that is synced with the host server to include the information necessary to decode the barcode. Alternatively, the barcode reading device may be coupled to the host server through a wired or wireless connection and may use the information on the host server to decode the barcode. It should be noted that the SMS embodiment disclosed above can be implemented using MMS and other similar types of messaging services. Also, while the above exemplary embodiment illustrates a single coupon per request, it is contemplated that an alternate embodiment would allow a plurality of coupons per request, resulting in the combination of the first coupon set and the second coupons set within a single barcode.

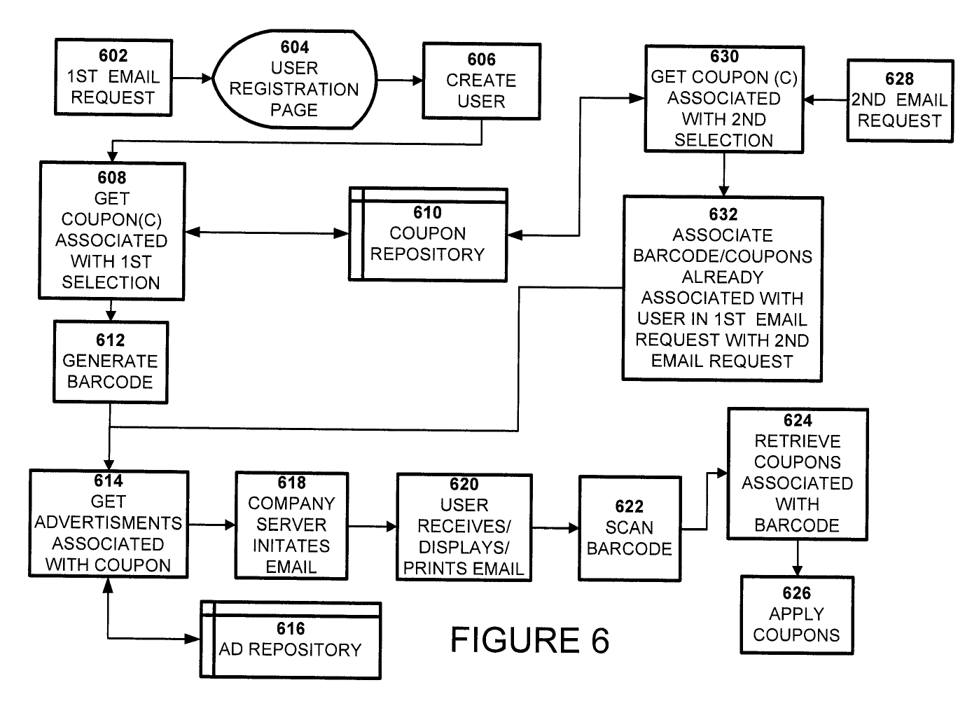

FIG. 6 is a flowchart of a method for generating a barcode and associating it with a plurality of coupons that were requested through the World Wide Web. In one embodiment, the user may request and receive a barcode representing a plurality of coupons through a web request from a mobile device. The user may make a first web request for at least one coupon 602. The web request may be made in the form of an email or made by inputting data to a web page. If the user is a new user, the user may be required to fill out a user registration page 604 to create a unique user ID 606. The user ID may he any unique set of alphanumeric characters, for example, an email address. The host server may retrieve the requested at least one coupon from the coupon repository 610, 608. If the user is a new user, the host server may generate a barcode and associate the barcode with the user 612. For example, the barcode may be associated with the user by linking it to the unique user ID. The host server may further associate the barcode and user with the at least one coupon requested by the first web request 612. The host server may retrieve advertisements from an advertisement repository 616 and combine the barcode and the advertisement into a message 614. The host server may select advertisements using location of the user, time coupon request was sent or current time, gender of user, age of user, previous coupons requested, and previous coupons redeemed. The host server may select advertisements based on any data available in the coupon request or user profile. The host server may initiate a web transmission to the user that includes the advertisement and the barcode 618. The web transmission may be a web page, an email, an SMS/MMS message or some other method for delivering the barcode and the advertisement to the user's mobile device. The user may receive the web transmission at their mobile device and display or print at least the barcode 620. The user may then scan the barcode using a barcode reading device at the place of purchase 622. The barcode reading device may retrieve the coupons associated with the user and apply those coupons to the purchase 624, 626. The barcode reading device may retrieve the coupons using a local database that is synced with the host server to include the information necessary to decode the barcode. Alternatively, the barcode reading device may be coupled to the host server through a wired or wireless connection and may use the information on the host server to decode the barcode.

Further, the user may initiate a second web request for a second at least one coupon. If the user sends the second web request for a second at least one coupon after using the first requested coupon, the host server will retrieve the user's barcode and perform the relevant steps from the first web request. However, if the user sends the second web request for the second at least one coupon prior to using the first at least one coupon, the host server may receive the second request and retrieve the user information associated with the user, such as the barcode and coupons currently associated with the user 630, e.g., the first at least one coupon. The host server may then retrieve the second at least one coupon 632 from the coupon repository 610. The host server may associate the barcode with the first at least one coupon and the second at least one coupon, resulting in the barcode being associated with a plurality of coupons 634. The host server may retrieve, from an advertisement repository 616, an advertisement that had been previously associated with the coupons 614 and combine the advertisement and the barcode. The host server may initiate a web transmission to the user that includes the advertisement and the barcode 618. The web transmission may be a web page, an email, an SMS/MMS message or some other method for delivering the barcode and the advertisement to the user's mobile device. The user may receive the web transmission at their mobile device and display or print at least the barcode 620. The user may then scan the barcode using a barcode reading device at the place of purchase 622. The barcode reading device may retrieve the coupons associated with the user and apply those coupons to the purchase 624, 626. The barcode reading device may retrieve the coupons using a local database that is synced with the host server to include the information necessary to decode the barcode. Alternatively, the barcode reading device may be coupled to the host server through a wired or wireless connection and may use the information on the host server to decode the barcode.

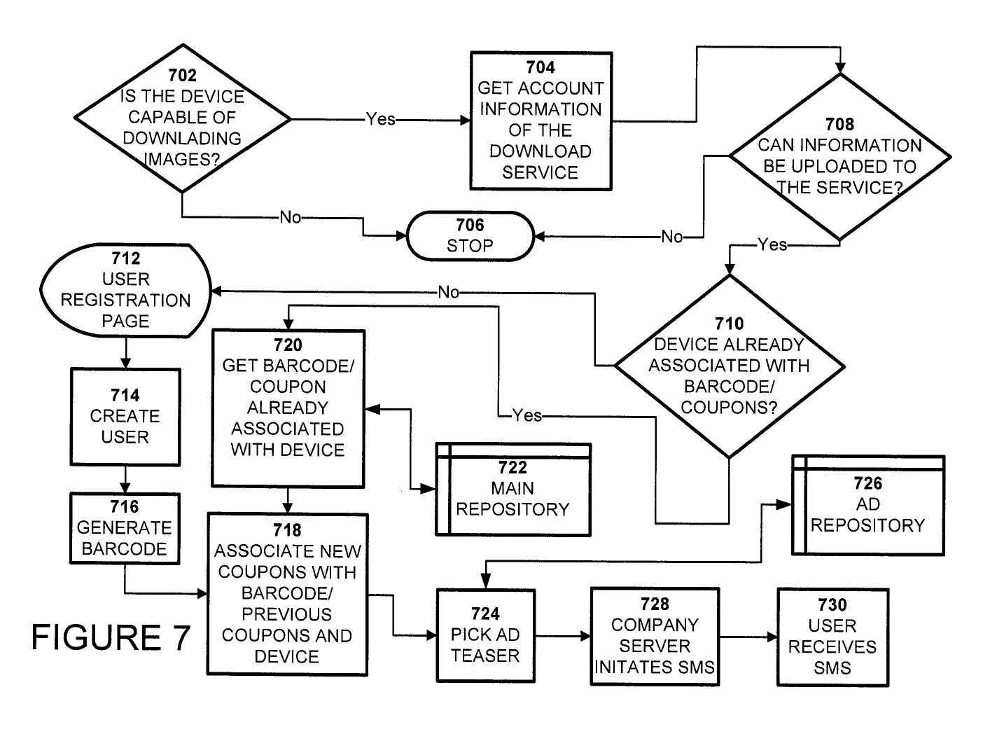

FIG. 7 is a flowchart of a method for generating a barcode, associating it with a plurality of coupons, and uploading to a download service which also includes downloading to portable devices. The user may download the barcode representing a plurality of coupons through a locally resident program or through the use of a download service. In one embodiment, the user may use the download service to download a program to the portable device to allow the portable device to interact with a host server. In an alternate embodiment, the user may use the download service to interact with the host server. The program may be proprietary software or may use commercially available methods, such as an iPhone application. The download service may be proprietary software or may use commercially available methods, such as Apple's iTunes. The user may connect their portable device to a computer to use the download service through various methods, including USB, Firewire, Bluetooth, WiFi and other similar communication protocols. Alternatively, the user may directly connect to the download service using a cellular phone network or the Internet. The user may also use the internet or a cellular network to allow the program to access the host server.

In operation, the user may use an application to receive at least one barcode representing a plurality of coupons. The application may be implemented using a download service or a program as described above. The application must first determine whether the portable device is capable of displaying images, such as a barcode or an advertisement 702. If the device is not capable of displaying an image, the application will display an error 706. If the device is capable of displaying images, the application will allow the user to request coupons through a user interface 704. If the user is a new user 708, the user will be directed towards a registration page to register 710. The user will be prompted for various identifying information, which may include name, date of birth, credit card information and other commercially relevant information 714. Once the user has created a user profile, the application will interact with a host server to generate a barcode that is associated with the user's profile 714. The host server may associate the barcode with the requested coupons 716. The host server may retrieve advertisements from an advertisement repository 728 and combine the barcode and the advertisement into a message 726. The host server may select advertisements using location of the user, time coupon request was sent or current time, gender of user, age of user, previous coupons requested, and previous coupons redeemed. The host server may select advertisements based on any data available in the coupon request or user profile. Once the advertisement and barcode have been combined, the host server may initiate a transmission of the advertisement/barcode combination to the user device. The application may use the connection between the computer and the portable device to transmit a barcode/coupon combination from the computer to the portable device 730. Alternatively, the application may use the Internet or a cellular network to transmit the advertisement/barcode combination directly to the portable device. The user may display the barcode the next time they are in a purchasing situation 732.

The user may reconnect to the application and request a second set of coupons. If the user reconnects after using the previously requested coupons, the application will retrieve the user's profile, including its associated barcode, and perform the relevant steps from the user's first connection. If, however, the user reconnects to the application and requests a second set of coupons before using the barcode, the application will detect that they are not a new user and will retrieve the user's existing user profile 718, including the barcode and the previously requested coupons from the first user connection. The application may use the information in the user's profile to retrieve the user's barcode and the coupons that have been previously associated with the barcode, but have not been redeemed 720. The application may interact with the host server to associate the barcode with the previously associated coupons and the requested second set of coupons 724. The host server may retrieve advertisements from an advertisement repository 728 and combine the barcode and the advertisement into a message 726. The host server may select advertisements using location of the user, time coupon request was sent or current time, gender of user, age of user, previous coupons requested, and previous coupons redeemed. The host server may select advertisements based on any data available in the coupon request or user profile. Once the advertisement and barcode have been combined, the host server may initiate a transmission of the advertisement/barcode combination to the user device using the connection between the computer and the portable device 730. Alternatively, the host server may use the Internet or a cellular network to transmit the advertisement/barcode combination directly to the portable device. The user may display the barcode the next time they are in a purchasing situation 732 and apply the previously associated coupons and newly requested second set of coupons to a purchase.

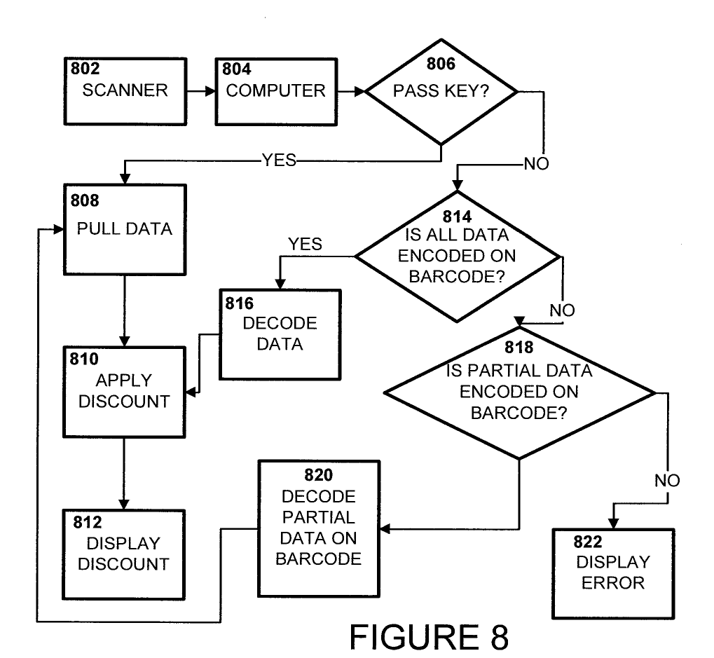

FIG. 8 is a flowchart of a method for retrieving data on a barcode representing a plurality of coupons. In one embodiment, the barcode reading device may read the barcode using a scanner 802 and pass the data to a computer 804. The computer may be programmed to determine whether the barcode data is a passkey 806. If the computer determines that the scanned barcode data is a passkey 806, the computer will pull the data associated with the barcode from a database 808. Once the data has been collected, the computer will apply the discount 810 and display the discount on the display device 812. If the barcode data received by the computer is not a passkey 806, the computer will check whether all the necessary data is included in the barcode data 814. If all of the necessary data is included in the barcode, the computer will decode the data 816, apply the discount and display the discount on the display device 812. If all of the necessary data is not included in the barcode data, the computer will determine whether partial data is encoded in the barcode data 818. If the barcode data includes partial data, the computer will decode the partial data 820, pull the remaining data 808 from a database using a partial passkey encoded into the barcode, apply the discount 810, and display the discount on the display device 812. If the barcode data does not contain a passkey 806, fully encoded data 814, and it does not have partial encoded data and a partial passkey 818, the computer will display an error 822. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications.

We note the following exemplary and novel features of the present disclosure and embodiments herein:

I claim:

1. A method for generating a barcode representing a plurality of coupons and initiating a transmission of the barcode to a barcode display device comprising
receiving a first request from a user for a first at least one coupon;
generating a barcode;
associating said barcode with said user and said first at least one coupon;
receiving a second request for a second at least one coupon;
associating said second at least one coupon with said barcode in addition to said first at least one coupon; and
initiating a transmission of said barcode to a barcode display device.

2. The method of claim 1 further comprising the steps of:
receiving and displaying said barcode on said barcode display device;
scanning said barcode and retrieving the data on said barcode using a barcode reading device; and
applying said requested first at least one coupon and said second at least one coupon associated with said barcode to a purchase.

3. The method of claim 1 wherein said step of generating a new barcode further comprises associating the barcode with a passkey in a database and said step of retrieving the data on said barcode further comprises decoding said passkey associated with said barcode using said database.

4. The method of claim 1 wherein said step of generating a new barcode further comprises coding all requested coupons into the barcode data and said step of retrieving the data on said barcode further comprises decoding said barcode data.

5. The method of claim 1 wherein said step of generating a new barcode further comprises:
associating the barcode with a partial passkey for a database and coding said barcode with partial coupon data; and
said step of retrieving the data on said barcode further comprises decoding said partial passkey associated with said barcode using said database and decoding said partial coupon data.

6. The method of claim 1 wherein said step of associating said first at least one coupon and said second at least one coupon with said barcode further comprises combining said barcode with an advertisement.

7. The method of claim 1 wherein said transmission is an SMS message.

8. The method of claim 1 wherein said transmission is an MMS message.

9. A method for initiating a transmission of a barcode representing a plurality of coupons to a barcode display device comprising:
receiving a request from a user for at least one coupon;
retrieving a barcode and at least one previously associated coupon corresponding to said user;
associating said user requested at least one coupon and said at least one previously associated coupon with said retrieved barcode; and
initiating a transmission of said barcode to said barcode display device.

10. The method of claim 9 further comprising the steps of:
receiving and displaying said barcode on said barcode display device;
scanning said barcode and retrieving the data on said barcode using a barcode reading device; and
applying said requested coupons associated with said barcode to a purchase.

11. The method of claim 9 wherein said step of associating said user requested at least one coupon and said at least one previously associated coupon with said retrieved barcode further comprises associating said barcode with a passkey in a database.

12. The method of claim 9 wherein said step of retrieving the data on said barcode further comprises decoding said passkey associated with said barcode using said database.

13. The method of claim 9 wherein said step of associating said user requested at least one coupon and said at least one previously associated coupon with said retrieved barcode further comprises coding all requested coupons into said barcode data.

14. The method of claim 10 wherein said step of retrieving the data on said barcode further comprises decoding said barcode data.

15. The method of claim 9 wherein said step of associating said user requested at least one coupon and said at least one previously associated coupon with said retrieved barcode further comprises associating the barcode with a partial passkey for a database and coding said barcode with partial coupon data;

16. The method of claim 10 wherein said step of retrieving the data on said barcode further comprises decoding said partial passkey associated with said barcode using said database and decoding said partial coupon data.

17. The method of claim 9 wherein said step of associating said user requested at least one coupon and said at least one previously associated coupon with said retrieved barcode further comprises combining said barcode with an advertisement.

18. The method of claim 9 wherein said transmission is an SMS message.

19. The method of claim 9 wherein said transmission is an MMS message.

20. A method for generating a barcode representing a plurality of coupons and initiating a transmission of a barcode representing the plurality of coupons to a barcode display device comprising:
receiving a request from a user for a plurality of coupons;
generating a barcode;
associating said plurality of coupons with said barcode; and
initiating a transmission of said barcode to a barcode display device.

21. The method of claim 20 further comprising the steps of,
receiving and displaying said barcode on said barcode display device;
scanning said barcode and retrieving the data on said barcode using a barcode reading device; and
applying said requested coupons associated with said barcode to a purchase.

22. The method of claim 20 wherein said step of associating said user requested plurality of coupons with said retrieved barcode further comprises associating said barcode with a passkey in a database.

23. The method of claim 21 wherein said step of retrieving the data on said barcode further comprises decoding said passkey associated with said barcode using said database.

24. The method of claim 20 wherein said step of associating said user requested plurality of coupons with said retrieved barcode further comprises coding all requested coupons into said barcode data.

25. The method of claim 21 wherein said step of retrieving the data on said barcode further comprises decoding said barcode data.

26. The method of claim 20 wherein said step of associating said user requested plurality of coupons with said retrieved barcode further comprises associating the barcode with a partial passkey for a database and coding said barcode with partial coupon data;

27. The method of claim 21 wherein said step of retrieving the data on said barcode further comprises decoding said partial passkey associated with said barcode using said database and decoding said partial coupon data.

28. The method of claim 20 wherein said step of associating said plurality of coupons with said barcode further comprises combining said barcode with an advertisement.

29. The method of claim 20 wherein said transmission occurs over email.

30. The method of claim 20 wherein said transmission occurs by uploading the barcode to a download service for download on to said barcode display device.

31. A method for initiating a transmission of a barcode representing a plurality of coupons to a barcode display device comprising:
receiving a request from a user for a plurality of coupons;
retrieving a barcode that corresponds to said user;
associating said plurality of coupons with said barcode; and
initiating a transmission of said barcode to a barcode display device.

32. The method of claim 31 wherein said step of retrieving a barcode that corresponds to said user includes retrieving at least one previously associated coupon corresponding with said user; and said step of associating said plurality of coupons with said barcode includes associating said plurality of coupons and said at least one previously associated coupon with said user barcode.

33. The method of claim 31 further comprising the steps of:
receiving and displaying said barcode on said barcode display device;
scanning said barcode and retrieving the data on said barcode using a barcode reading device; and
applying said requested coupons associated with said barcode to a purchase.

34. The method of claim 31 wherein said step of associating said user requested plurality of coupons with said retrieved barcode further comprises associating said barcode with a passkey in a database.

35. The method of claim 31 wherein said step of retrieving the data on said barcode further comprises decoding said passkey associated with said barcode using said database.

36. The method of claim 33 wherein said step of associating said user requested plurality of coupons with said retrieved barcode further comprises coding all requested coupons into said barcode data.

37. The method of claim 33 wherein said step of retrieving the data on said barcode further comprises decoding said barcode data.

38. The method of claim 31 wherein said step of associating said user requested plurality of coupons with said retrieved barcode further comprises associating the barcode with a partial passkey for a database and coding said barcode with partial coupon data;

39. The method of claim 33 wherein said step of retrieving the data on said barcode further comprises decoding said partial passkey associated with said barcode using said database and decoding said partial coupon data.

40. The method of claim 31 wherein said step of associating said plurality of coupons with said barcode further comprises combining said barcode with an advertisement.

41. The method of claim 31 wherein said transmission occurs over email.

42. The method of claim 31 wherein said transmission occurs by uploading the barcode to a download service for download on to said barcode display device.
